(19) United States
(12) Patent Application Publication
(10) Pub. No.: US 2006/0075843 A1
(43) Pub. Date: Apr. 13, 2006

(54) Steering column height adjusting mechanism

(76) Inventors: Wolfram Hofschulte, Bonndorf (DE); Rolf Lohner, Villingen-Schwenningen (DE); Keven Mohring, Wiedergeltingen (DE)

Correspondence Address: O'Shea, Getz & Kosakowski, P.C.;Suite 912, 1500 Main Street, Springfield, MA, 01115, US

(21) Appl. No.: 11/250,183

(22) Filed: Oct. 13, 2005

(30) Foreign Application Priority Data
Oct. 13, 2004 (DE) 10 2004 049 960.8

(51) Int. Cl. B62D 1/16

(52) U.S. Cl. 74/492

(57) ABSTRACT

The invention relates to a steering column height adjusting mechanism having a base body (1), a steering column guide (2) for accommodating and guiding a steering column, a steering column support (20) for supporting the steering column guide (2) pivotably relative to the base body (1), an adjusting element (3) for pivoting the steering column guide (2) relative to the base body (1), and a drive device (4) for adjusting the adjusting element (3), the drive device (4) being arranged on the base body.

### PRIORITY INFORMATION

This patent application claims priority from German patent application 10 2004 049 960.8 filed Oct. 13, 2004, which is hereby incorporated by reference.

### BACKGROUND OF THE INVENTION

The present invention relates to the field of steering column height adjustment mechanisms.

U.S. Pat. No. 5,275,066 discloses a steering column height adjusting mechanism. The mechanism comprises a base body that is rigidly attached to a vehicle frame as a simple support element. The mechanism also includes a steering column guide in the form of a jacket tube for accommodating and guiding a steering column, and a steering column support for supporting the steering column guide pivotably relative to the base body. The mechanism further comprises an adjusting element in the form of a rectangular lever system for pivoting the steering column guide relative to the base body, the adjusting element being pivotably supported in its angle section on the base body via an adjusting element support. A drive device adjusts the adjusting element and the drive device is attached to the steering column guide.

German patent application DE 41 03 202 A1 discloses a steering column for motor vehicles wherein a steering shaft made up of a lower shaft and an upper shaft, which are connected to each other by a universal joint, are rotatably supported in a housing. The housing includes a lower housing fixed to the body and an upper housing movable with respect thereto about an axis transverse to the lengthwise axis of the steering column. The lower housing and the upper housing are both adjustably connected to each other by intermediate members having mutually engaging gears and actuatable by a motor. Intermediate members made up of a worm gear segment rigidly arranged on the upper housing lie with the center point at the crossing of the axes of the universal joint and are aligned parallel to the lengthwise axis of the steering column. A worm engages teeth of a worm gear segment, with the worm being supported on the lower housing in fixed fashion relative to the body and drivable by the motor. This arrangement comprises a large number of individual components and, as a worm and worm gear design having a tilting axis, is difficult in terms of construction.

Further single-spindle or multispindle drives as well as individual components are known for example from U.S. Pat. No. 4,925,210, European Patent EP 0834437, German Patent DE 196 28 520 C2, and German Patent Application DE 33 22 863 A1.

There is a need for an improved steering column height adjusting mechanism.

### SUMMARY OF THE INVENTION

A steering column height adjusting mechanism includes a base body, a steering column guide for accommodating and guiding a steering column, and a steering column support for supporting the steering column guide pivotably relative to the base body. The mechanism also includes an adjusting element for pivoting the steering column guide relative to the base body, and a drive device for adjusting the adjusting element with the drive device being arranged on the base body.

The drive device may include a worm drive.

The drive device may include a two-stage, in particular self-inhibiting worm drive.

The adjusting element may be pivotably supported on the base body via an adjusting element support.

The adjusting element may be coupled to the drive device by a worm gear segment on one side of the adjusting element support and with a clearance relative to the adjusting element support.

The adjusting element and the drive device for adjusting the adjusting element may be coupled to a worm gear segment via a hemigloboidal doubling.

The steering column support is arranged on the adjusting element on the other side of the adjusting element support and with a clearance relative to the adjusting element support.

Advantageous is a mechanism wherein, particularly in the case of a hemigloboidal doubling, a worm axis of a worm engaging in the worm gear runs obliquely with respect to a spanned pivoting plane of a steering column axis or, respectively, to a rotation plane of the worm gear segment and intersects said plane.

The mechanism may include backlash-free supports for supporting the adjusting element and the steering column guide.

The drive device and/or the adjusting element may be integrated into components of a steering column of a vehicle. The drive device may be arranged on the base body.

Due to the simple and compact structure, the steering column height adjusting mechanism provides advantages such as a well-defined adjustment speed and a well-defined adjustment travel, minimal or, even better, no backlash, well-defined deformation stability and well-defined crash requirements in an economical design. In particular, a small electric drive can be employed for such a height adjustment of a vehicle steering column.

Such a steering column height adjusting mechanism represents an adapted development with a view to small structural volume, low required adjusting force of the drive device, adequately high adjustment speed, strength, backlash, assembly and crash requirements. In addition, it is capable of adaptation in the course of further development. The concept can be adapted to a wide variety of vehicle types. The merging of the steering column with drive components makes possible a small number of parts, which at the same time leads to a compact and reduced construction. With an eye to assembly, such a steering column height adjusting mechanism can provide demarcations of assembly responsibilities in modularly selectable fashion. As a consequence, a small electric motor having relatively low power consumption can be employed.

The relatively small number of rotation points with just a single possible backlash at the gear segment prevents chaining or addition of backlash values. Because of the small number of moving parts, the potential for vibration is rather small. The construction permits well-defined and distortion-free lock features. The drive unit in such an arrangement becomes an integral component of the power system. By adapting the gearing to the resonant behavior of the system, the acoustics can be controlled, the constant lever arm ratios during operation permitting a uniform noise effect throughout the travel range together with no relative movements of the components.

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1 is a schematic illustration of a steering column height adjusting mechanism with the individual components in exploded representation, including a representation of a hemigloboidal doubling;

FIG. 2 is a perspective view of the steering column height adjusting mechanism in the assembled state; and

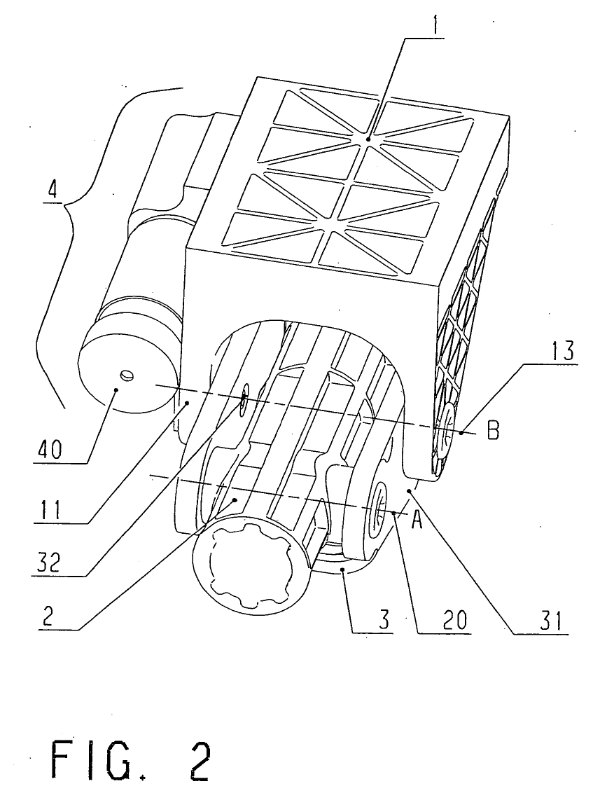

FIG. 3 shows a further perspective view of the steering column height adjusting mechanism.

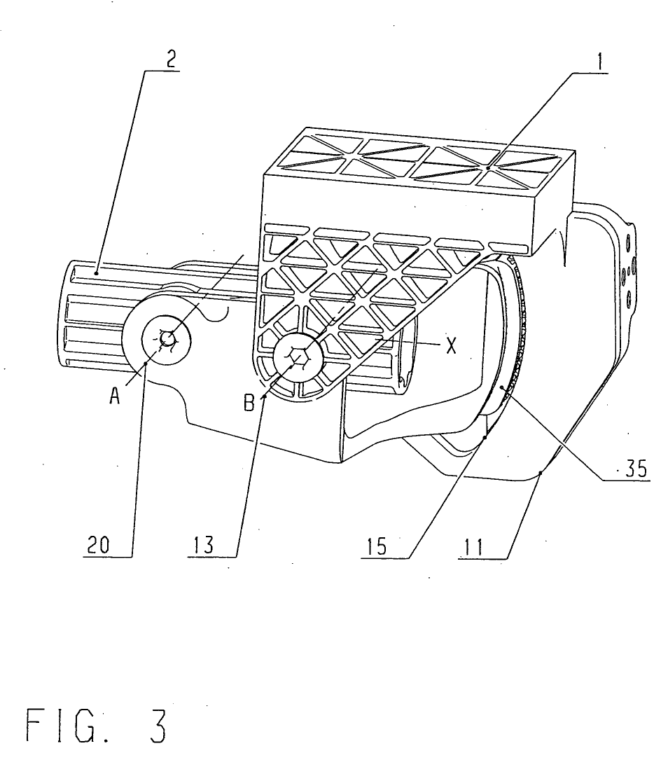

### DETAILED DESCRIPTION OF THE INVENTION

As can be seen from the drawings, a steering column height adjusting mechanism comprises a large number of individual components, of which the ones that will be described in what follows are substantially those that are important for an understanding of the arrangement and mode of functioning of a preferred embodiment of the inventive steering column height adjusting mechanism.

A steering column guide 2 is supported via an adjusting element 3 in a base body 1. A drive device 4, attached laterally to the base body 1, serves for automatic adjusting of the steering column guide 2 relative to the base body 1.

The base body 1 forms a housing for the steering column guide 2, where the steering column guide 2 is supported pivotably in a plane perpendicular to its lengthwise axis X. The base body 1 may be fashioned substantially in the shape of an inverted U having its side walls 11 parallel to lengthwise axis X. A design aligned in inverted fashion, that is, a U-shaped arrangement, is also feasible. The steering column height adjusting mechanism is preferably installed in the vehicle with a guide. The steering column height adjusting mechanism is preferably coupled to the vehicle frame via the base body 1.

In the side walls 11 of the base body 1, adjacent to the front end of the base body 1 as shown in the drawings, there is arranged an adjusting element support 13 having an adjusting element support axis B perpendicular to lengthwise axis X. Leading thereto are through holes 12 through the side walls 11 of the base body 1. The adjusting element support axis B runs through the entire arrangement parallel to, and with a clearance relative to, steering column support axis A.

The adjusting element support 13 supports the adjusting element 3, which forms a type of stirrup, perpendicular to the lengthwise axis X in the base body 1. In this way, the adjusting element 3 is pivotable in a plane in which the steering column guide 2 is pivotable. The adjusting element 3 is preferably fashioned substantially in a U-shape with two side walls 31. The arrangement of the side walls 31 is chosen such that the outer sides of the side walls 31 of the adjusting element 3 are arranged inside the side walls 11 of the base body 1, relative movements of the adjusting element 3 and the base body 1 being permitted in as backlash-free a manner as possible. The adjusting element 3 has its side walls 31 extending parallel to the steering column guide 2 and the side walls 11 of the base body 1 in the direction of the lengthwise axis X. Between the front and rear end section of the adjusting element 3 as shown in the drawings, corresponding support elements, in particular through the holes 32 to accommodate the support 13, are fashioned in both of the side walls 31 of the adjusting element. After the insertion of the adjusting element 3 into the base body 1, these are both pivotable with respect to each other about the adjusting element support axis B.

In the front section of the side walls 31 of the adjusting element 3 as shown in the drawings, support points 33, in particular through holes 33 to accommodate a steering column support 20, are arranged perpendicular to lengthwise axis X. The steering column guide 2, which is preferably fashioned as a tube and accommodates and guides a steering column, has in its lateral circumferential region corresponding support points, in particular holes 21 to accommodate elements of the steering column support 20. In the assembled state, the steering column support 20 in the front section of the adjusting element 3 supports the steering column guide 2 pivotably about the steering column support axis A. Furthermore, the arrangement of the steering column guide 2 and the adjusting element 3 is additionally pivotable about the adjusting element support axis B of the adjusting element support 13 relative to the base body 1. The steering column support axis B and the adjusting element support axis A run parallel to each other.

A drive device 4 is preferably mounted laterally and externally with respect to one of the side walls 11 of the base body 1. The drive device 4 includes an electric motor drive 40 whose drive shaft and lengthwise axis is aligned in the pivoting plane of the steering column guide 2 and, as appropriate in dependence on its pivoted position, in a position parallel to the lengthwise. axis X. The drive 40 is attached to a drive housing 44, a drive shaft having a drive worm 41 intruding into drive housing 44. A first drive worm 41 drives a second drive stage 43 having a second worm 42. The second drive stage 43 is supported inside the drive housing 44 substantially perpendicularly to the lengthwise axis of the drive shaft and the first drive worm 41.

The second drive worm 42 of the second drive stage 43 drives a worm gear segment or gear segment 35, which is a component of the adjusting element 3. The worm gear segment or gear segment 35 may be formed by a one-piece, or preferably by a separate, structural element rigidly connected to a corresponding side wall 31 of the adjusting element 3. The structural element forming the worm gear 35 intrudes laterally from the rear segment of the adjusting element 3 as shown in the drawings into a hole 15, which is correspondingly fashioned in the adjacent side wall 11 of the base body 1 between the adjusting element 3 and the drive device 4.

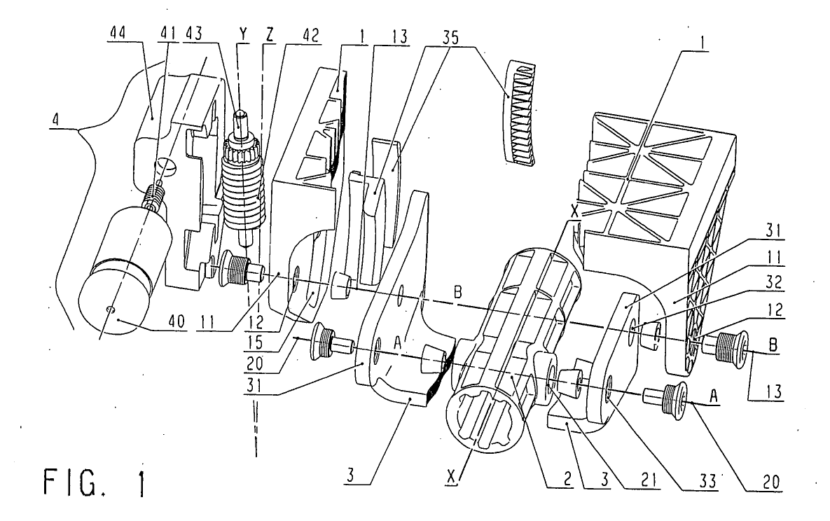

The hole 15 in the side wall 11 of the base body 1 is preferably fashioned in the shape of an arc in order to guide worm gear segment or gear segment 35 in or through. The worm gear segment or gear segment 35, which has a lateral clearance with respect to the adjusting element 3, is correspondingly fashioned in the shape of an arc. The teeth of the worm gear segment or gear segment 35 are fashioned on the rear face as shown in the drawings, as is sketched with the detail view in FIG. 1. These teeth lie outside the side wall 11 and engage laterally in the second worm 42 of the second drive stage 43, which the second worm 42 is arranged in front thereof. A correspondingly hemigloboidal doubling is on the worm gear segment or gear segment 35, in which doubling the teeth are completely formed only in the region of direct tooth engagement.

A worm axis Y of the second worm 42 does not run perpendicularly in the drawings but runs at an angle to a perpendicular Z. The prolongation of the worm axis Y of the second worm 42 thus intersects a spanned pivoting plane of the steering column axis X or the rotation plane of the worm gear segment or gear segment 35. The second worm 42 thus runs obliquely to the worm gear segment 35.

A driving of the drive worm 41 by the drive 40 thus effects a driving of the second worm 42 and via the second worm an adjustment of the worm gear segment or gear segment 35. In this way, the adjusting element 3 is pivoted about the adjusting element support 13, the steering column guide 2 furthermore being pivoted, via the steering column support 20, relative to the adjusting element 3 and the base body 1.

The adjusting drive may include a two-stage self-inhibiting worm drive. In the second drive stage 43, force is transferred by a worm gear segment or gear segment 35 to the adjusting element 3, whose front support is located in the side walls 11 of the base body 1. The adjusting element 3 is pivoted in an ordinarily vertical direction about this support point 13, B, the pivoting movement being transferred via the second support point, at the front in the drawings and ordinarily at the rear in the installed state, that is, the steering column support 20, A, to the steering column guide 2, in which the steering column is supported. This arrangement thus permits an adjustment of the steering column via two rotation or support axes A, B between the steering column guide 2 and the adjusting element 3 or between the adjusting element 3 and the base body 1 with preferably backlash-free support elements 20, 13. In this way, freedom from backlash is permitted without a chaining of backlash values. Especially advantageous is the hemigloboidal doubling on the worm gear segment or gear segment 35, by which freedom from backlash is permitted with high tooth stability, in that the worm gear segment or gear segment 35 in the hole 15 is correspondingly sized and supported in mutually matched fashion. A saving in components relative to known embodiments is made possible by the integration of individual drive elements into the components of the steering column or of the steering column support. Furthermore, the arrangement of the drive 4 and the adjusting element 3 in the overall arrangement contributes to the stiffness of the steering column accommodation, because a closed system of forces is made possible.

Although the present invention has been illustrated and described with respect to several preferred embodiments thereof, various changes, omissions and additions to the form and detail thereof, may be made therein, without departing from the spirit and scope of the invention.

What is claimed is:

1. A steering column height adjusting mechanism, comprising:
a base body;
a steering column guide for accommodating and guiding a steering column;
a steering column support for supporting the steering column guide pivotably relative to the base body and about a first axis B;
an adjusting element for pivoting the steering column guide about a second axis relative to the base body; and
a drive device attached to the base body for adjusting the adjusting element.

2. The mechanism of claim 1, wherein the drive device comprises a worm drive.

3. The mechanism of claim 1, wherein the drive device has a two-stage self-inhibiting worm drive.

4. The mechanism of claim 1, wherein the adjusting element is pivotably supported on the base body via an adjusting element support.

5. The mechanism of claim 4 wherein the adjusting element is coupled to the drive device by a worm gear segment on one side of the adjusting element support and with a clearance relative to the adjusting element support.

6. The mechanism of claim 4, wherein the adjusting element and the drive device for adjusting the adjusting element are coupled to a worm gear segment via a hemigloboidal doubling.

7. The mechanism of claim 5, wherein the steering column support is arranged on the adjusting element on the other side of the adjusting element support and with a clearance relative to the adjusting element support.

8. The mechanism of claim 6, wherein a worm axis (Y) of a second worm device engaging in the worm gear segment runs obliquely with respect to a spanned pivoting plane of a steering column axis (X) or, respectively, to a rotation plane of the worm gear segment and intersects the plane.

9. The mechanism of claim 1, comprising backlash-free supports (13, 20) for supporting the adjusting element and the steering column guide.

10. The mechanism of claim 1, wherein the drive device is arranged on the base body.

11. A steering column height adjusting mechanism, comprising:
a support structure;
an adjusting element that is pivotally connected to the support structure such that the adjusting element may pivot about an axis B;
a steering column guide that is pivotally connected to the adjusting element such that the steering column guide may pivot about an axis A that is perpendicular to a longitudinal axis of the steering column guide, wherein
the steering column guide is rotatably coupled to a drive device.

12. The steering column height adjusting mechanism of claim 11, where the steering column guide is rotatably coupled to the drive device by a gear mechanism comprising a worm gear.

13. The steering column height adjusting mechanism of claim 12, wherein the gear mechanism comprises a first worm gear.

14. The steering column height adjusting mechanism of claim 11, where the support structure comprises first and second sidewalls separated by a panel, where the first sidewall includes a first opening and the second sidewall includes a second opening co-axial with respect to the first opening along the B axis.

15. The steering column height adjusting mechanism of claim 14, where the adjusting element includes a first adjustment element sidewall that includes a third opening therein and a second adjustment element sidewall that includes a fourth opening therein, wherein the first, second, third and fourth openings are co-axial along axis B, and the first sidewall and the first adjustment element sidewall are adjacent and the second sidewall and the second adjustment sidewall are adjacent.

16. The steering column height adjusting mechanism of claim 15, where the first adjusting element sidewall also includes a fifth opening and the second adjusting element sidewall also includes a sixth opening, which is co-axial with the fifth opening along axis A, where fasteners are inserted through the fifth and sixth opening to pivotally engage sidewalls of the steering column guide.
